(19) United States
(12) Patent Application Publication
(10) Pub. No.: US 2025/0322333 A1
(43) Pub. Date: Oct. 16, 2025

(54) Systems and Methods for Automated, Collaborative Workflows with Actionable Items

(71) Applicant: Moxo, Inc, Cupertino, CA (US)

(72) Inventors: He Huang, San Jose, CA (US); Subrah S. Iyar, Los Gatos, CA (US); Karrtik Rao Aria, Los Gatos, CA (US); Mukund C. Rao Aria, Los Gatos, CA (US)

(21) Appl. No.: 18/631,473

(22) Filed: Apr. 10, 2024

(51) Int. Cl. G06Q 10/0631; G06Q 10/10

(52) U.S. Cl. CPC G06Q 10/06316; G06Q 10/103

(57) ABSTRACT

Systems, devices, and methods for automated workflow are disclosed. For example, an automated workflow system may include a workflow template database configured to store a plurality of workflow templates. Each of the workflow templates may include a workflow having a sequence of actionable items. The automated workflow system may include at least one memory storing instructions and at least one processor configured to execute the instructions to perform operations. The operations may include electronically communicating first workflow presentation instructions to a user device. The operations may include electronically receiving workflow modification instructions from the user device. The workflow modification instructions may include a request to modify the workflow. The operations may include automatically generating a modified workflow based on the workflow modification instructions. The operations may include electronically communicating second workflow presentation instructions to the user device.

### BACKGROUND

Business service teams implementing and managing complex services may gain efficiency from automated workflows, especially when a plurality of users are involved in the workflow.

Conventional approaches to automated workflow may include a workflow template. In conventional approaches, workflow templates may be separate from workflow implementations. Such workflow templates may only be modified by users outside the workflow implementation.

Problems may arise in conventional approaches when users desire to modify automated workflows in an efficient manner. Problems may also arise in conventional approaches when users of an automated workflow desire to communicate in an efficient manner.

Accordingly, given the shortcomings of conventional approaches, a need exists for unconventional approaches that efficiently enable users to modify and utilize automated workflows.

This Background is provided to introduce a brief context for the Detailed Description that follows. This Background is not intended to be an aid in determining the scope of the claimed subject matter nor be viewed as limiting the claimed subject matter to implementations that solve any or all of the shortcomings or problems presented above.

### BRIEF DESCRIPTION OF THE SEVERAL VIEWS OF THE DRAWINGS

The accompanying drawings, which are incorporated in and constitute a part of this specification, illustrate several embodiments and, together with the description, serve to explain the disclosed principles. In the drawings:

FIG. 1 depicts an example environment for providing an automated workflow, consistent with disclosed embodiments.

FIG. 2 depicts an example process for communicating workflow instructions, consistent with disclosed embodiments.

FIG. 3 depicts an example automated workflow system, consistent with disclosed embodiments.

FIG. 4 depicts an example process for requesting workflow modification, consistent with disclosed embodiments.

FIG. 5 depicts a first example process for automated workflow, consistent with disclosed embodiments.

FIG. 6 depicts an example device for requesting workflow modification, consistent with disclosed embodiments.

FIG. 7 depicts an example process for communicating workflow modification instructions, consistent with disclosed embodiments.

FIG. 8 depicts a second example process for automated workflow, consistent with disclosed embodiments.

FIG. 9 depicts an example process for executing a workflow job service for a workflow instance with actionable items, consistent with disclosed embodiments.

FIG. 10 illustrates an example workflow presentation with example actionable items, consistent with disclosed embodiments.

FIG. 11 illustrates an example workflow presentation with example actionable item details, consistent with disclosed embodiments.

FIG. 12 illustrates an example workflow presentation with example options for modifying an example actionable item, consistent with disclosed embodiments.

FIG. 13 illustrates an example workflow presentation with example options for editing an example actionable item, consistent with disclosed embodiments.

FIG. 14 illustrates an example workflow presentation after receiving an example request to modify the workflow by adding an actionable item, consistent with disclosed embodiments.

FIG. 15 illustrates an example workflow presentation with example options for adding an actionable item, consistent with disclosed embodiments.

FIG. 16 illustrates an example workflow presentation after receiving an example request to modify the workflow by adding a file request, consistent with disclosed embodiments.

FIG. 17 illustrates an example workflow presentation with example options for adding a file request, consistent with disclosed embodiments.

FIG. 18 illustrates an example workflow presentation after adding a file request to existing example actionable items, and a first aspect of an example collaboration feed, consistent with disclosed embodiments.

FIG. 19 illustrates an example workflow presentation and a second aspect of an example collaboration feed, consistent with disclosed embodiments.

FIG. 20 illustrates an example annotation, consistent with disclosed embodiments.

FIG. 21 illustrates an example workflow presentation with an example list of users associated with the workflow, consistent with disclosed embodiments.

FIG. 22 illustrates an example workflow presentation with an example reassignment selection, consistent with disclosed embodiments.

### DETAILED DESCRIPTION OF EMBODIMENTS

The disclosed embodiments provide unconventional systems, devices, and methods for automated, collaborative workflow. Embodiments consistent with the present disclosure are rooted in computer technology and may be implemented using a combination of conventional hardware and software as well as specialized hardware and software, such as one or more systems and/or devices constructed and/or programmed specifically for performing disclosed operations and/or functions associated with the disclosed methods. The following discloses example embodiments which are explanatory only and are not restrictive of the claims.

The disclosed systems and methods provide greater efficiency over conventional approaches to workflow implementation and modification. The disclosed systems and methods provide greater efficiency over conventional approaches that require exiting a workflow implementation to modify the workflow. The disclosed systems and methods provide greater efficiency over conventional approaches that require utilizing separate workflow and collaboration applications. The disclosed systems and methods provide greater efficiency over conventional approaches that don't support reassigning one or more action items in a workflow from a first user to a second user.

As used herein, a workflow is a flow or sequence of action items or activities desired to reach a business goal. A sequence of action items or activities may be repeatable.

As used herein, an automated workflow is implemented in a computing environment. An automated workflow may be provided as part of a computer implemented workspace.

As used herein, an actionable item is an action item or activity that is actionable to a user through employment of one or more of the disclosed systems and/or devices. An actionable item may associated with specific operations and/or functions that may be executed by the computer technology disclosed herein.

As used herein, a collaboration feed is implemented in a computing environment. A collaboration feed may be provided as part of a computer implemented workspace. A collaboration feed may be configured to enable two or more users to communicate. A collaboration feed may be configured to illustrate a stream of communication content between two or more users.

Embodiments consistent with the present disclosure may include an automated workflow system. The automated workflow system may be coupled to a computer network. The automated workflow system may comprise a workflow template database. The workflow template database may be configured to store a plurality of workflow templates. Each of the workflow templates may comprise a workflow having a sequence of actionable items. The automated workflow system may comprise at least one memory storing instructions. The automated workflow system may comprise at least one processor configured to execute the instructions to perform operations. The operations may comprise electronically communicating first workflow presentation instructions to a user device. The first workflow presentation instructions may be configured to present the workflow to a user of the user device. The operations may comprise electronically receiving workflow modification instructions from the user device. The workflow modification instructions may comprise a request to modify the workflow. The operations may comprise automatically generating a modified workflow based on the workflow modification instructions. The operations may comprise electronically communicating second workflow presentation instructions to the user device. The second workflow presentation instructions may be configured to present the modified workflow to the user.

In at least some embodiments, workflow modification instructions may be received from a user device while a sequence of actionable items remain actionable to a user of the user device. The ability for the user to utilize the actionable items of a workflow may be referred to as being in the workflow. The ability for a user to request and/or view one or more modifications to a workflow while being in the workflow provides greater efficiency over conventional approaches where workflows may only be modified by users while being out of the workflow. In these conventional approaches, the items in the workflow may not be actionable until the user exists a modification environment and returns to a workflow implementation environment.

In at least some embodiments, actionable items may comprise a form, a file request, an approval, an acknowledgement, a signature, a calendar item, a task, an integration, and/or any other type of item or activity employed to reach a business goal. A form may comprise an upload of a form, a completion of filling out a form, a download of a form, and/or any other type of form activity while a user is in a workflow. A file request may comprise requesting a file and/or fulfilling a request while a user is in the workflow. An approval may comprise approving an actionable item by a user while the user is in the workflow. An acknowledgement may comprise acknowledging an actionable item while a user is in the workflow. A signature may comprise signing a form and/or a document while a user is in the workflow. A calendar item may comprise adding an entry on a calendar for one or more additional users while a user is in the workflow. For example, the entry on the calendar may be related to a call, a meeting, or a video meeting. A task may comprise assigning a task to one or more users while a user is in the workflow. An integration may comprise loading an external application from a third party service provider while the user is in the workflow. For example, an external application may comprise a document signing application or an identity verification application. A milestone may comprise setting a milestone related to one or more additional actionable items while a user is in the workflow.

In at least some embodiments, a request to modify a workflow may comprise adding an actionable item. The actionable item may be added to the workflow while a user is in the workflow.

In at least some embodiments, a request to modify a workflow may comprise removing an actionable item. The actionable item may be removed from the workflow while a user is in the workflow.

In at least some embodiments, a request to modify a workflow may comprise marking an actionable item as complete. The actionable item may be marked complete while a user is in the workflow.

In at least some embodiments, one or more actionable items may include access to an Application Programming Interface (API) associated with a third party service. Access to the API may be added to a workflow while a user is in the workflow.

At least some embodiments may include an audit database. Operations may comprise storing workflow modification instructions in the audit database.

In at least some embodiments, one or more actionable items may be assignable to one or more users associated with a workflow.

In at least some embodiments, operations may comprise electronically receiving reassignment instructions from a user device. The reassignment instructions may comprise a request to reassign one or more actionable items from a first user to a second user. The operations may comprise automatically generating an updated workflow based on the reassignment instructions. The operations may comprise electronically communicating updated workflow presentation instructions to the user device. The updated workflow presentation instructions may be configured to present the updated workflow.

In at least some embodiments, reassignment instructions may be received from a user device while a sequence of actionable items remain actionable to a user of the user device.

At least some embodiments may include an audit database. Operations may comprise storing reassignment instructions in the audit database.

In at least some embodiments, operations may comprise electronically communicating first feed instructions to a user device. The first feed instructions may be configured to present a collaboration feed to a user of the user device. The operations may comprise electronically receiving collaboration instructions from the user device. The collaboration instructions may comprise a request to add a collaboration item to the collaboration feed. The operations may comprise automatically generating a modified collaboration feed. The modified collaboration feed may be based on the collaboration instructions. The operations may comprise electronically communicating second feed instructions to the user device. The second feed instructions may be configured to present the modified collaboration feed to the user.

In at least some embodiments, collaboration instructions may be received from a user device while a sequence of actionable items remain actionable to a user of the user device. The ability for a user to request additions and/or view one or more additions to a communication feed related to a workflow while being in the workflow provides greater efficiency over conventional approaches where communication feeds and workflows are provided by separate applications.

In at least some embodiments, a collaboration item may comprise a message comprising text, a message comprising a video, a request for a video meeting, a file, a link to a file, a link to a data repository, an annotation, and/or any other type of collaborative content.

In at least some embodiments, a collaboration feed and/or a modified collaboration feed may be associated with a specific actionable item in a workflow. In these embodiments, the collaboration feed and/or the modified collaboration feed may be available to users associated with the specific actionable item.

In at least some embodiments, a collaboration feed and/or a modified collaboration feed may be associated with all actionable items in a workflow. In these embodiments, the collaboration feed and/or the modified collaboration feed may be available to all users associated with the workflow.

At least some embodiments may include an audit database. Operations may comprise storing collaboration instructions in the audit database.

Embodiments consistent with the present disclosure may include a method for automated workflow. The method may comprise accessing a workflow template database configured to store a plurality of workflow templates. Each of the workflow templates may comprise a workflow having a sequence of actionable items. The method may comprise electronically communicating first workflow presentation instructions to a user device. The first workflow presentation instructions may be configured to present the workflow to a user. The method may comprise electronically receiving workflow modification instructions from the user device. The workflow modification instructions may comprise a request to modify the workflow. The method may comprise automatically generating a modified workflow based on the workflow modification instructions. The method may comprise electronically communicating second workflow presentation instructions to the user device. The second workflow presentation instructions may be configured to present the modified workflow to the user.

Embodiments consistent with the present disclosure may include a computing device. The computing device may be coupled to a computer network. The computing device may comprise at least one memory storing instructions. The computing device may comprise at least one processor configured to execute the instructions to perform operations. The operations may comprise electronically receiving first workflow presentation instructions from an automated workflow system. The first workflow presentation instructions may be configured to present a workflow to a user. The workflow may have a sequence of actionable items. The operations may comprise electronically communicating workflow modification instructions to the automated workflow system. The workflow modification instructions may comprise a request to modify the workflow. The operations may comprise electronically receiving second workflow presentation instructions from the automated workflow system. The second workflow presentation instructions may be configured to present a modified workflow to the user. The modified workflow may be based on the workflow modification instructions.

In at least some embodiments, workflow modification instructions may be communicated to an automated workflow system while a sequence of actionable items remain actionable to a user of a computing device.

In at least some embodiments, operations may comprise electronically receiving first workflow template instructions from an automated workflow system. The first workflow template instructions may be configured to present a plurality of workflow templates to a user of a computing device. Each of the workflow templates may have a sequence of actionable items. The operations may comprise electronically communicating a workflow template selection to the automated workflow system. The workflow template selection may comprise a request to select one of the workflow templates. The operations may comprise electronically receiving second workflow template instructions from the automated workflow system. The second workflow template instructions may be configured to present a specific workflow to the user. The specific workflow may be based on the workflow template selection.

In at least some embodiments, one or more actionable items may be assignable to one or more users associated with a workflow.

In at least some embodiments, operations may comprise electronically communicating reassignment instructions to an automated workflow system. The reassignment instructions may comprise a request to reassign one or more actionable items from a first user to a second user. The operations may comprise automatically receiving updated workflow presentation instructions from the automated workflow system. The updated workflow presentation instructions may be configured to present an updated workflow. The updated workflow may be based on the reassignment instructions.

In at least some embodiments, reassignment instructions may be communicated to an automated workflow system while a sequence of actionable items remain actionable to a user of the user device.

In at least some embodiments, operations may comprise electronically receiving first feed instructions from an automated workflow system. The first feed instructions may be configured to present a collaboration feed to a user of a computing device. The operations may comprise electronically communicating collaboration instructions to the automated workflow system. The collaboration instructions may comprise a request to add a collaboration item to the collaboration feed. The operations may comprise electronically receiving second feed instructions from the automated workflow system. The second feed instructions may be configured to present the modified collaboration feed to the user. The modified collaboration feed may be based on the collaboration instructions.

In at least some embodiments, collaboration instructions may be communicated to an automated workflow system from a computing device while a sequence of actionable items in a workflow remain actionable to a user of the computing device.

Embodiments consistent with the present disclosure may include a method for modifying an automated workflow. The method may comprise electronically receiving first workflow presentation instructions from an automated workflow system. The first workflow presentation instructions may be configured to present a workflow to a user. The workflow may have a sequence of actionable items. The method may comprise electronically communicating workflow modification instructions to the automated workflow system. The workflow modification instructions may comprise a request to modify the workflow. The method may comprise electronically receiving second workflow presentation instructions from the automated workflow system. The second workflow presentation instructions may be configured to present a modified workflow to the user. The modified workflow may be based on the workflow modification instructions.

In at least some embodiments, a method for modifying an automated workflow may comprise electronically receiving first workflow template instructions from an automated workflow system. The first workflow template instructions may be configured to present a plurality of workflow templates to a user. Each of the workflow templates may have a sequence of actionable items. The method may comprise electronically communicating a workflow template selection to the automated workflow system. The workflow template selection may comprise a request to select one of the workflow templates. The method may comprise electronically receiving second workflow template instructions from the automated workflow system. The second workflow template instructions may be configured to present a specific workflow to the user. The specific workflow may be based on the workflow template selection.

In at least some embodiments, a method for modifying an automated workflow may comprise electronically receiving first feed instructions from an automated workflow system. The first feed instructions may be configured to present a collaboration feed to a user. The method may comprise electronically communicating collaboration instructions to the automated workflow system. The collaboration instructions may comprise a request to add a collaboration item to the collaboration feed. The method may comprise electronically receiving second feed instructions from the automated workflow system. The second feed instructions may be configured to present the modified collaboration feed to the user. The modified collaboration feed may be based on the collaboration instructions.

Reference will now be made in detail to example embodiments, examples of which are illustrated in the accompanying drawings and disclosed herein. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting. As will be appreciated by one skilled in the art, the components and arrangement of components included in the disclosed systems and devices may vary. For example, an automated workflow system may further include other components or devices not depicted in the accompanying drawings that perform or assist in the performance of one or more processes consistent with the disclosed embodiments. For example, a user device may further include other components or devices not depicted in the accompanying drawings that perform or assist in the performance of one or more processes consistent with the disclosed embodiments. For example, a computing device may further include other components or devices not depicted in the accompanying drawings that perform or assist in the performance of one or more processes consistent with the disclosed embodiments. The components and arrangements shown in the accompanying drawings are not intended to limit the disclosed embodiments, as the components used to implement the disclosed processes and features may vary.

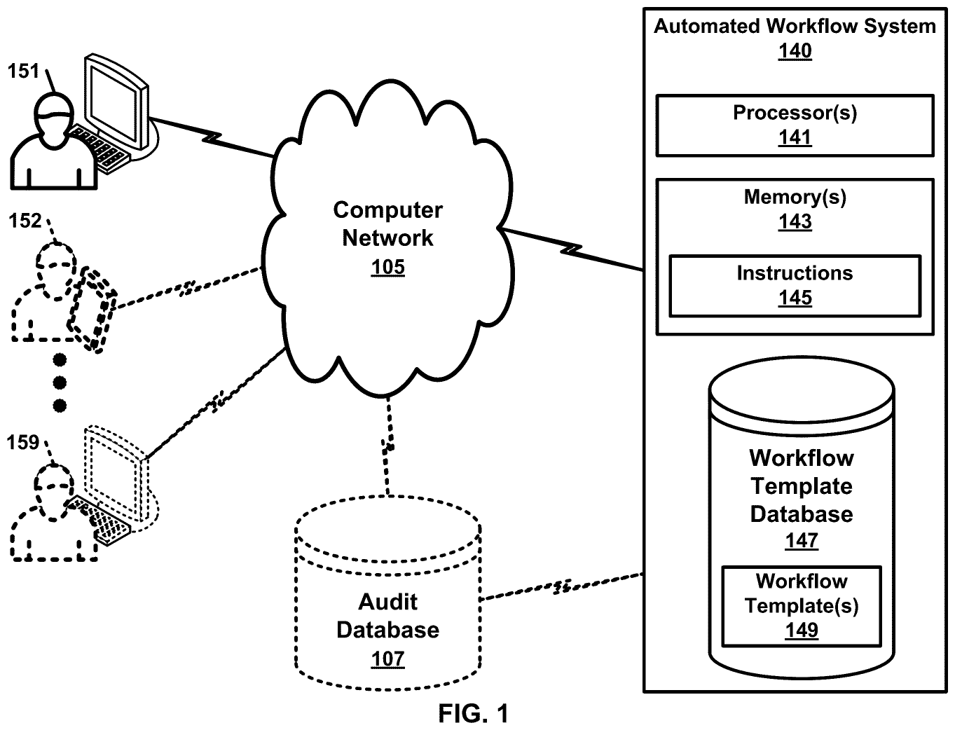

FIG. 1 depicts an example environment for providing an automated workflow, consistent with disclosed embodiments. Automated workflow system 140 may be communicatively coupled to computer network 105. The automated workflow system 140 may comprise workflow template database 147. The workflow template database 147 may be configured to store one or more workflow templates 149. Each of the workflow templates 149 may comprise a workflow. The workflow may comprise a sequence of actionable items. The automated workflow system 140 may comprise at least one memory 143. The at least one memory 143 may be configured to store instructions 145. The automated workflow system 140 may comprise at least one processor 141. The at least one processor 141 may be configured to execute the instructions 145 to perform operations. One or more user devices (151, 152, . . . 159) may be communicatively coupled to the computer network 105. Audit database 107 may be communicatively coupled to the computer network 105. The audit database 107 may be communicatively coupled directly to the automated workflow system 140. Alternatively, the audit database 107 may be a part of the automated workflow system 140.

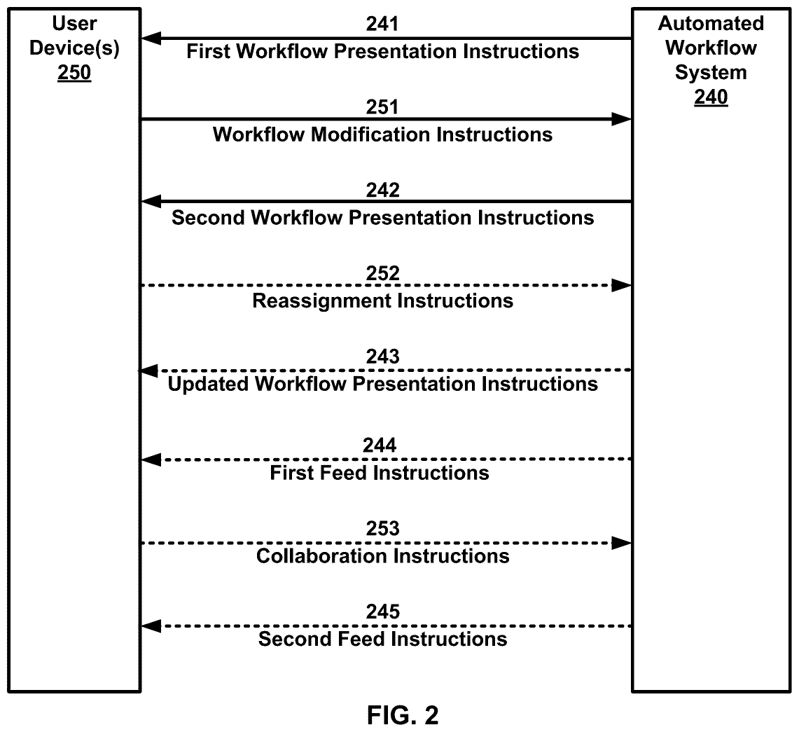

FIG. 2 depicts an example process for communicating workflow instructions, consistent with disclosed embodiments. Automated workflow system 240 may be configured to electronically communicate first workflow presentation instructions 241 to one or more user devices 250. The first workflow presentation instructions 241 may be configured to present a workflow to one or more users of the user devices 250. The automated workflow system 240 may be configured to electronically receive workflow modification instructions 251 from one of the user devices 250. The workflow modification instructions 251 may comprise a request to modify the workflow. The automated workflow system 240 may be configured to automatically generate a modified workflow based on the workflow modification request. The automated workflow system 240 may be configured to electronically communicate second workflow presentation instructions 242 to the user devices 250. The second workflow presentation instructions 242 may be configured to present the modified workflow to one or more users of the user devices 250. The automated workflow system 240 may be configured to electronically receive reassignment instructions 252 from one of the user devices 250. The reassignment instructions 252 may comprise a request to reassign one or more actionable items from a first user to a second user. The automated workflow system 240 may be configured to automatically generate an updated workflow based on the reassignment instructions. The automated workflow system 240 may be configured to electronically communicate updated workflow presentation instructions 243 to the user devices 250. The updated workflow presentation instructions 243 may be configured to present the updated workflow to one or more users of the user devices 250. The automated workflow system 240 may be configured to electronically communicate first feed instructions 244 to the user devices 250. The first feed instructions 244 may be configured to present a collaboration feed to one or more users of the user devices 250. The automated workflow system 240 may be configured to electronically receive collaboration instructions 253 from one of the user devices 250. The collaboration instructions 253 may comprise a request to add a collaboration item to the collaboration feed. The automated workflow system 240 may be configured to automatically generate a modified collaboration feed based on the collaboration instructions. The automated workflow system 240 may be configured to electronically communicate second feed instructions 245 to the user devices 250. The second feed instructions 245 may be configured to present the modified collaboration feed to one or more users of the user devices 250.

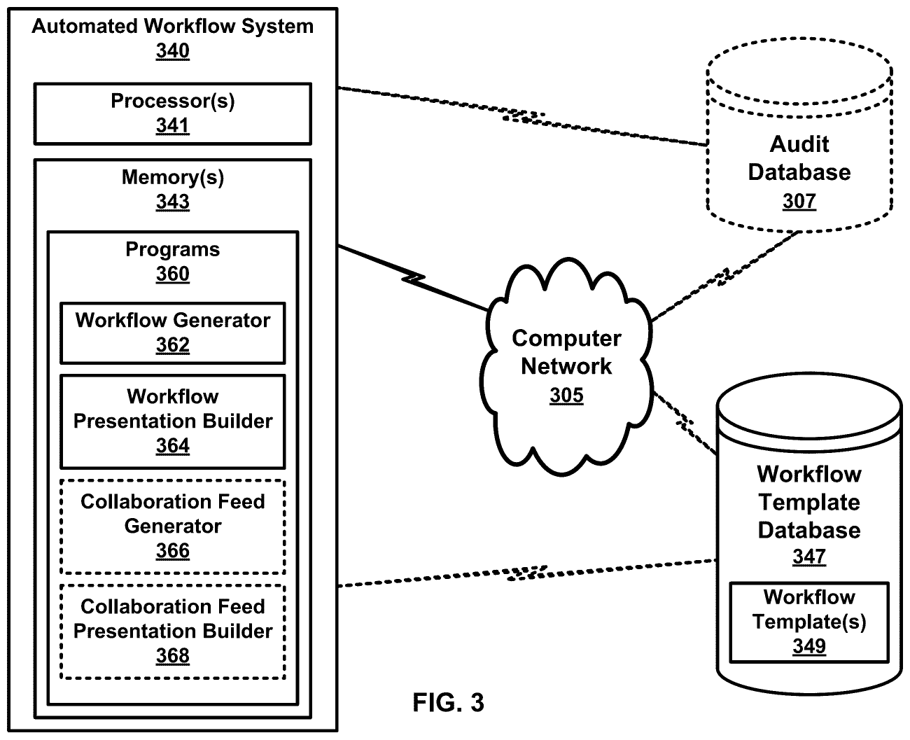

FIG. 3 depicts an example automated workflow system, consistent with disclosed embodiments. Automated workflow system 340 may be communicatively coupled to computer network 305. The automated workflow system 340 may be communicatively coupled to workflow template database 347. The workflow template database 347 may be configured to store one or more workflow templates 349. Each of the workflow templates 349 may comprise a workflow. The workflow may comprise a sequence of actionable items. The automated workflow system 340 may be communicatively coupled to audit database 307. The automated workflow system 340 may comprise at least one memory 343. The at least one memory 343 may comprise one or more programs 360. Each of the programs 360 may comprise instructions. The automated workflow system 340 may comprise at least one processor 341. The at least one processor 341 may be configured to execute the instructions to perform operations. The programs 360 may comprise workflow generator 362. The workflow generator 362 may comprise workflow generating instructions. The programs 360 may comprise workflow presentation builder 364. The workflow presentation builder 364 may comprise workflow presentation building instructions. The programs 360 may comprise collaboration feed generator 366. The collaboration feed generator 366 may comprise collaboration feed generating instructions. The programs 360 may comprise collaboration feed presentation builder 368. The collaboration feed presentation builder 368 may comprise collaboration feed presentation building instructions.

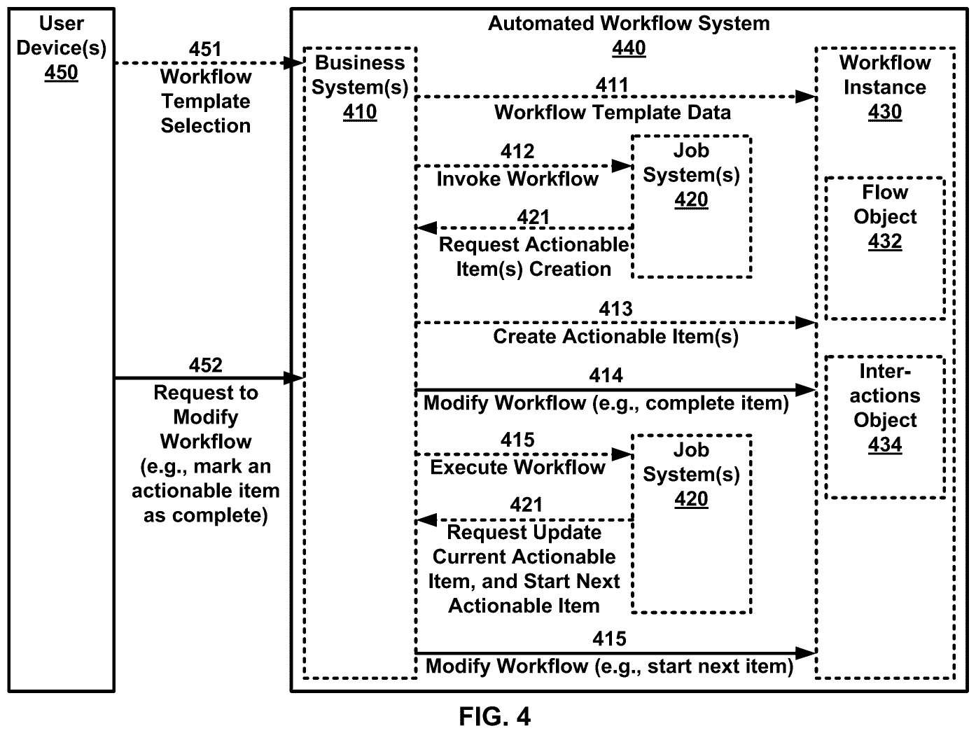

FIG. 4 depicts an example process for requesting workflow modification, consistent with disclosed embodiments. Automated workflow system 440 may comprise one or more business systems 410. The one or more business systems 410 may comprise at least one memory storing business instructions. The one or more business systems 410 may comprise at least one processor configured to execute the business instructions to perform business operations. Automated workflow system 440 may comprise one or more job systems 420. The one or more job systems 420 may comprise at least one memory storing job instructions. The one or more job systems 420 may comprise at least one processor configured to execute the job instructions to perform job operations. The business operations may comprise receiving a workflow template selection 451 from a user device 450. The business operations may comprise creating a workflow instance 430 based on workflow template data 411. The workflow template data 411 may be based on the workflow template selection 451. The workflow instance 430 may comprise a flow object 432. The flow object 432 may comprise data required to implement a workflow. The workflow instance 430 may comprise an interactions object 434. The interactions object 434 may be configured to store all interactions associated with the workflow. The business operations may comprise communicating instructions to invoke a workflow job service 412 to one of the job systems 420. The job operations may comprise communicating a request for actionable item creation 421 for the next actionable item in the workflow to one of the business systems 410. The business operations may comprise creating the next actionable item 413 in the flow object 432 of the workflow instance 430. The business operations may comprise starting the next actionable item in the workflow. The business operations may comprise receiving a request to modify the workflow 452 from a user device 450. For example, the request to modify the workflow 452 may comprise a request to mark an actionable item as complete. The business operations may comprise modifying the workflow 414. Modifying the workflow may comprise modifying the flow object 432 in the workflow instance 430. In this example, modifying the workflow 414 may comprise completing the current actionable item. The business operations may comprise communicating instructions to execute the workflow 415 to one of the job systems 420. The job operations may comprise communicating a request to update the current actionable item and start the next actionable item 421 in the workflow to one of the business systems 410. The business operations may comprise modifying the workflow 415. In this example, modifying the workflow 415 may comprise starting the next actionable item in the workflow.

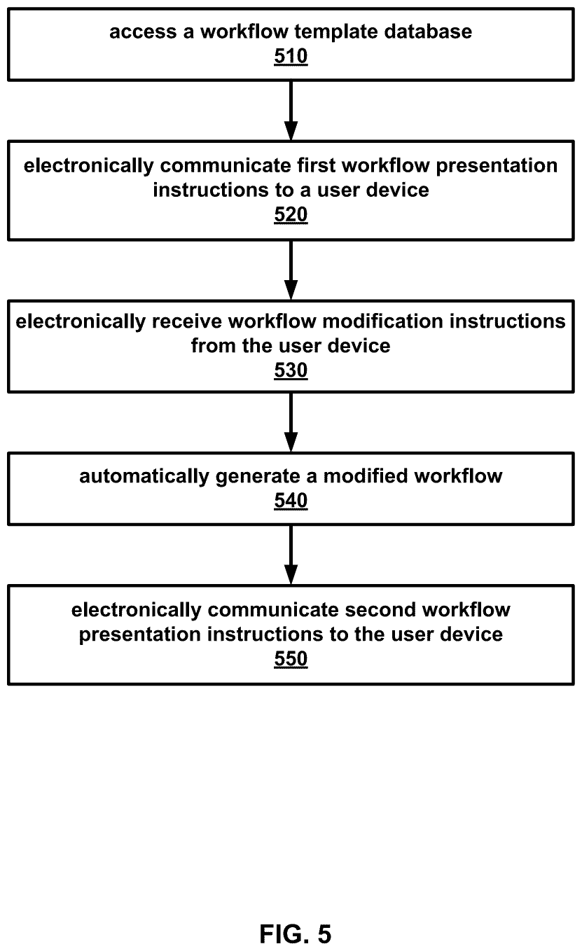

FIG. 5 depicts a first example process for automated workflow, consistent with disclosed embodiments. A workflow template database may be accessed at 510. First workflow presentation instructions may be electronically communicated to a user device at 520. Workflow modification instructions may be electronically received from the user device at 530. A modified workflow may be automatically generated at 540. Second workflow presentation instructions may be electronically communicated to the user device at 550.

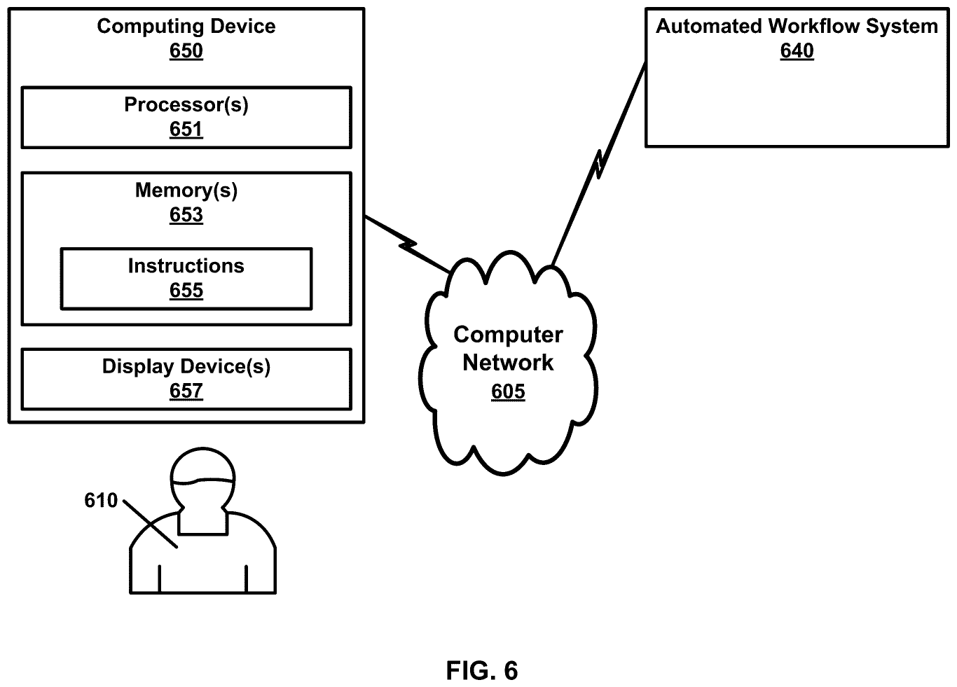

FIG. 6 depicts an example device 650 for requesting workflow modification, consistent with disclosed embodiments. Computing device 650 may be communicatively coupled to computer network 605. The computer network 605 may be communicatively coupled to automated workflow system 640. The computing device 650 may comprise at least one memory 653. The at least one memory 653 may be configured to store instructions 665. The computing device 650 may comprise at least one processor 651. The at least one processor 651 may be configured to execute the instructions 665 to perform operations. The computing device 650 may comprise one or more display devices 657. The computing device 650 may be configured to present a workflow to user 610 through employment of one or more of the display devices 657.

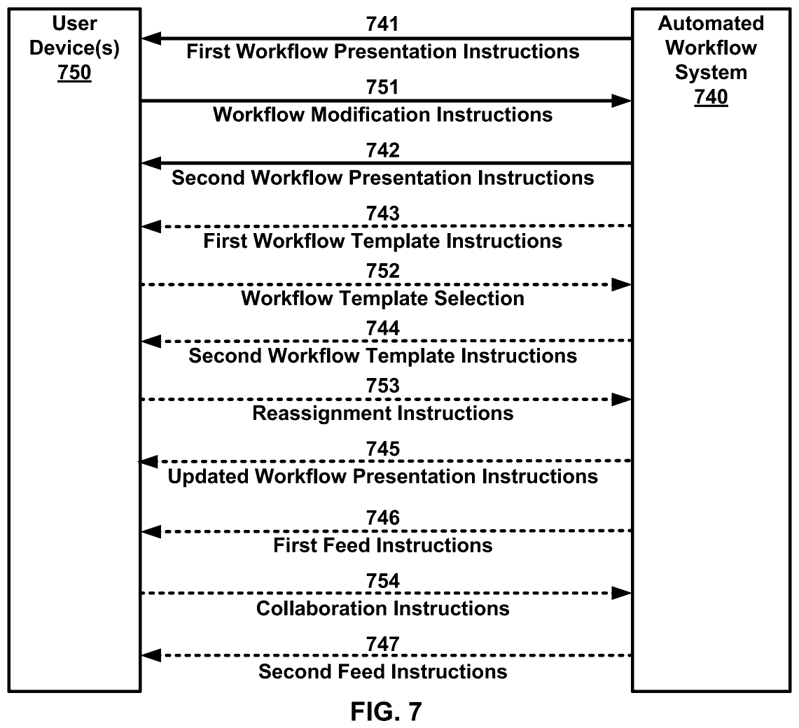

FIG. 7 depicts an example process for communicating workflow modification instructions, consistent with disclosed embodiments. At least one user device 750 may be configured to electronically receive first workflow presentation instructions 741 from automated workflow system 740. The at least one user device 750 may be configured to electronically communicate workflow modification instructions 751 to the automated workflow system 740. The at least one user device 750 may be configured to electronically receive second workflow presentation instructions 742 from the automated workflow system 740. The at least one user device 750 may be configured to electronically receive first workflow template instructions 743 from the automated workflow system 740. The at least one user device 750 may be configured to electronically communicate a workflow template selection 752 to the automated workflow system 740. The at least one user device 750 may be configured to electronically receive second workflow template instructions 744 from the automated workflow system 740. The at least one user device 750 may be configured to electronically communicate reassignment instructions 753 to the automated workflow system 740. The at least one user device 750 may be configured to automatically receive updated workflow presentation instructions 745 from the automated workflow system. The at least one user device 750 may be configured to electronically receive first feed instructions 746 from the automated workflow system 740. The at least one user device 750 may be configured to electronically communicate collaboration instructions 754 to the automated workflow system 740. The at least one user device 750 may be configured to electronically receive second feed instructions 747 from the automated workflow system 740.

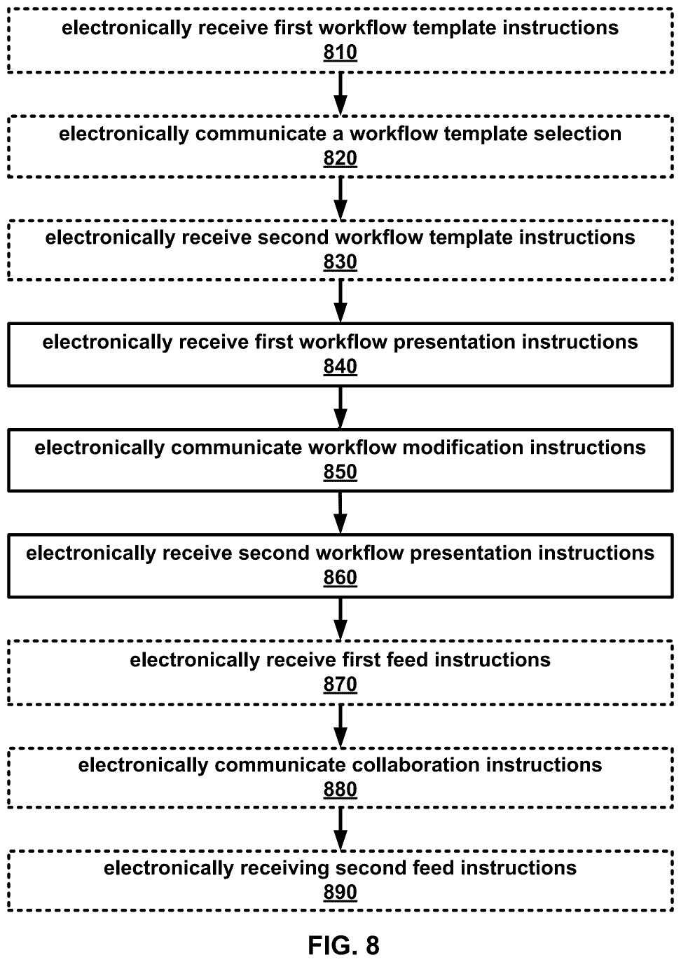

FIG. 8 depicts a second example process for automated workflow, consistent with disclosed embodiments. First workflow template instructions may be electronically received at 810. A workflow template selection may be electronically communicated at 820. Second workflow template instructions may be electronically received at 830. First workflow presentation instructions may be electronically received at 840. Workflow modification instructions may be electronically communicated at 850. Second workflow presentation instructions may be electronically received at 860. First feed instructions may be electronically received at 870. Collaboration instructions may be electronically communicated at 880. Second feed instructions may be electronically received at 890.

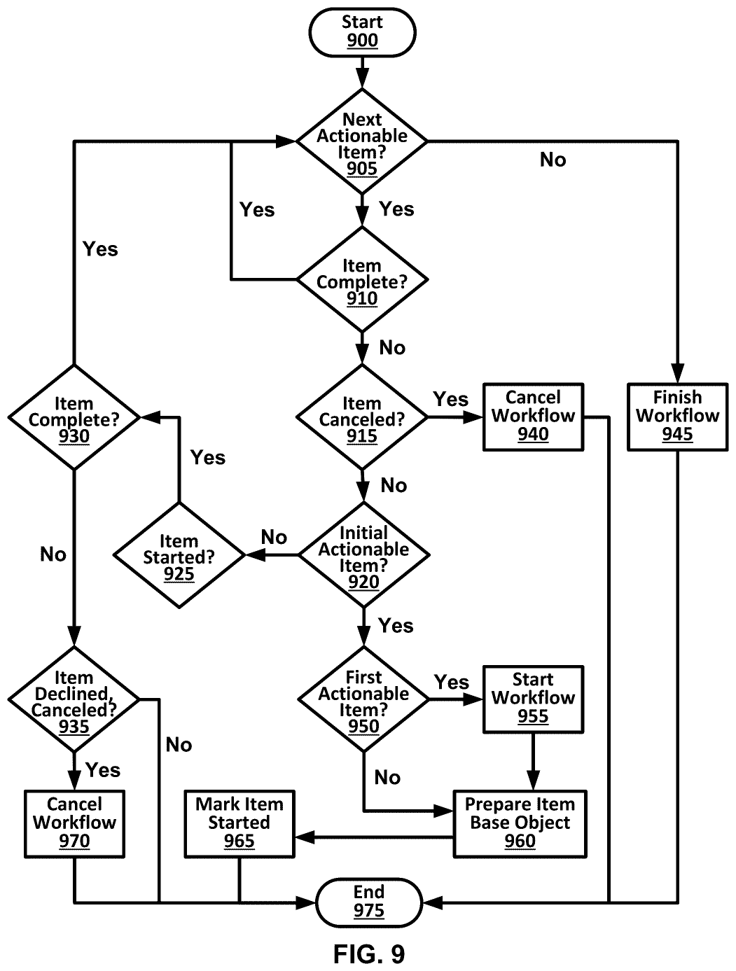

FIG. 9 depicts an example process for executing a workflow job service for a workflow with actionable items, consistent with disclosed embodiments. The process may start at 900. Existence of a next actionable item in a workflow may be determined at 905. A completion status of the next actionable item may be determined at 910. A cancellation status of the next actionable item may be determined at 915. An initial status of the next actionable item may be determined at 920. A started status of the next actionable item may be determined at 925. A completion status of the next actionable item may be determined at 930. A determination of the next actionable item being declined or canceled may be made at 935. The workflow may be cancelled at 940. The workflow may be finished at 945. A determination that the next actionable item is the first actionable item may be made at 950. The workflow may be started at 955. The actionable item base object may be prepared at 960. The actionable item may be marked as started at 965. The workflow may be cancelled at 970. The process may end at 975. The process may be repeated when the status changes for any of the actionable item in the workflow.

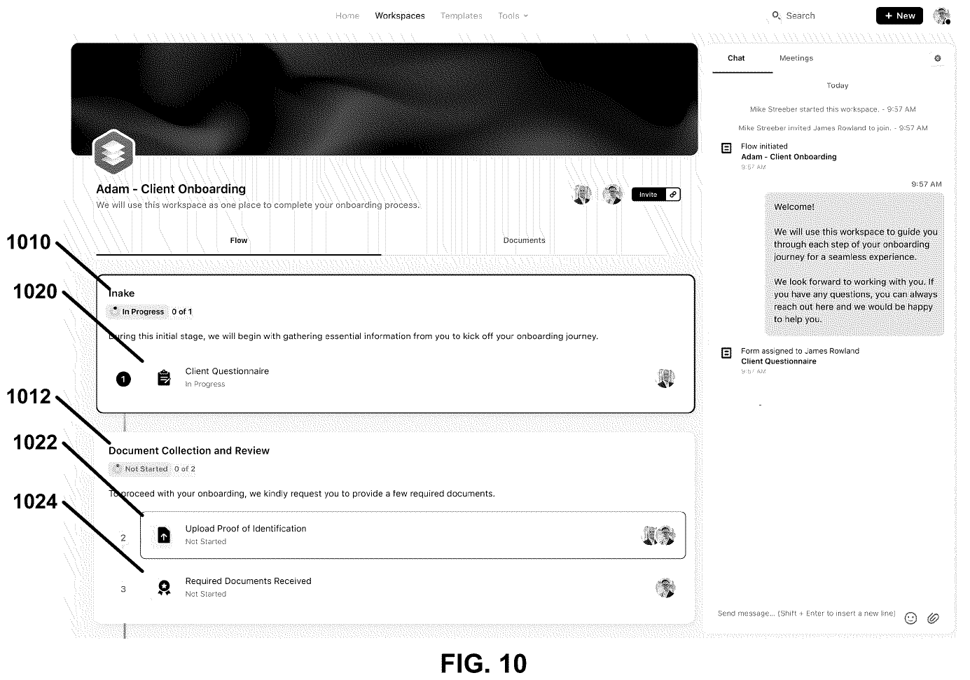

FIG. 10 illustrates an example workflow presentation with example actionable items, consistent with disclosed embodiments. The workflow presentation may illustrate a workflow with a first milestone 1010. The workflow may comprise a first actionable item 1020. The first actionable item 1020 may comprise a form. In this example, the form may comprise a client questionnaire. In this example, the first actionable item 1020 is associated with the first milestone 1010. Therefore, in this example, once the form of actionable item 1020 is complete, the first milestone 1010 may be marked as complete automatically. The workflow may comprise a second milestone 1012. The workflow may comprise a second actionable item 1022. The second actionable item 1022 may comprise a file request. In this example, the file request may comprise proof of identification. The workflow may comprise a third actionable item 1024. The third actionable item 1024 may comprise an acknowledgement. In this example, the acknowledgement may comprise acknowledging that the required documents have been received. In this example, the second actionable item 1022 and the third actionable item 1024 are associated with the second milestone 1012. Therefore, in this example, once the file of actionable item 1022 is uploaded, and the acknowledgement of actionable item 1024 is complete, the second milestone 1012 may be marked as complete automatically.

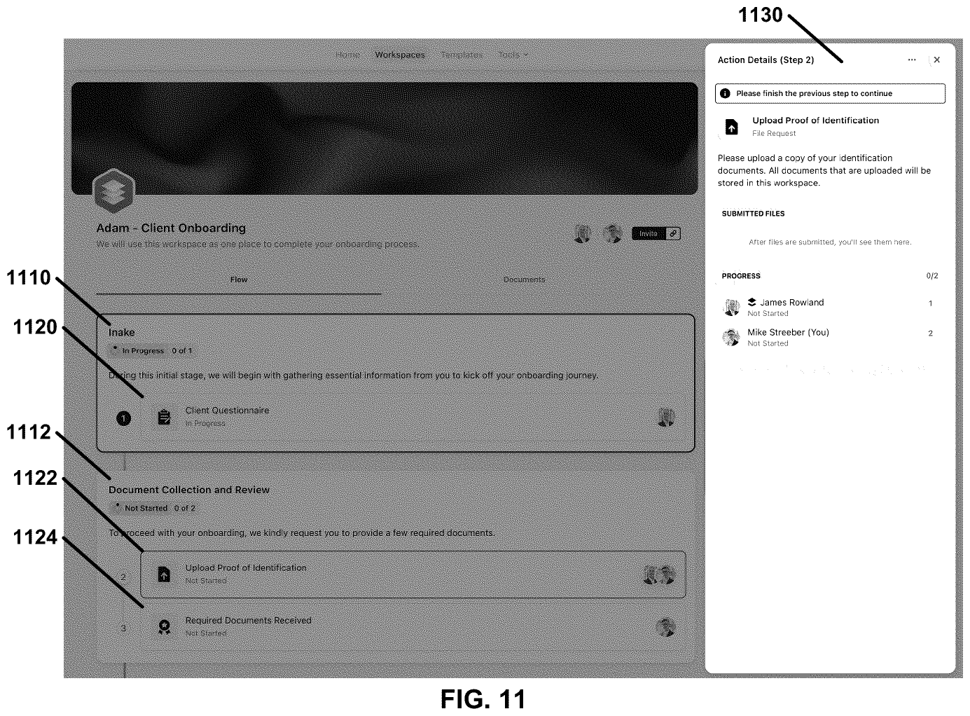

FIG. 11 illustrates an example workflow presentation with example actionable item details, consistent with disclosed embodiments. The workflow presentation may illustrate a workflow with a first milestone 1110. The workflow may comprise a first actionable item 1120. The first actionable item 1120 may comprise a form. In this example, the form may comprise a client questionnaire. In this example, the first actionable item 1120 is associated with the first milestone 1110. The workflow may comprise a second milestone 1112. The workflow may comprise a second actionable item 1122. The second actionable item 1122 may comprise a file request. In this example, the file request may comprise proof of identification. The workflow may comprise a third actionable item 1124. The third actionable item 1124 may comprise an acknowledgement. In this example, the acknowledgement may comprise acknowledging that the required documents have been received. In this example, the second actionable item 1122 and the third actionable item 1124 are associated with the second milestone 1112. The workflow presentation may comprise actionable item details 1130. In this example, the actionable item details 1130 may be associated with the second actionable item 1122.

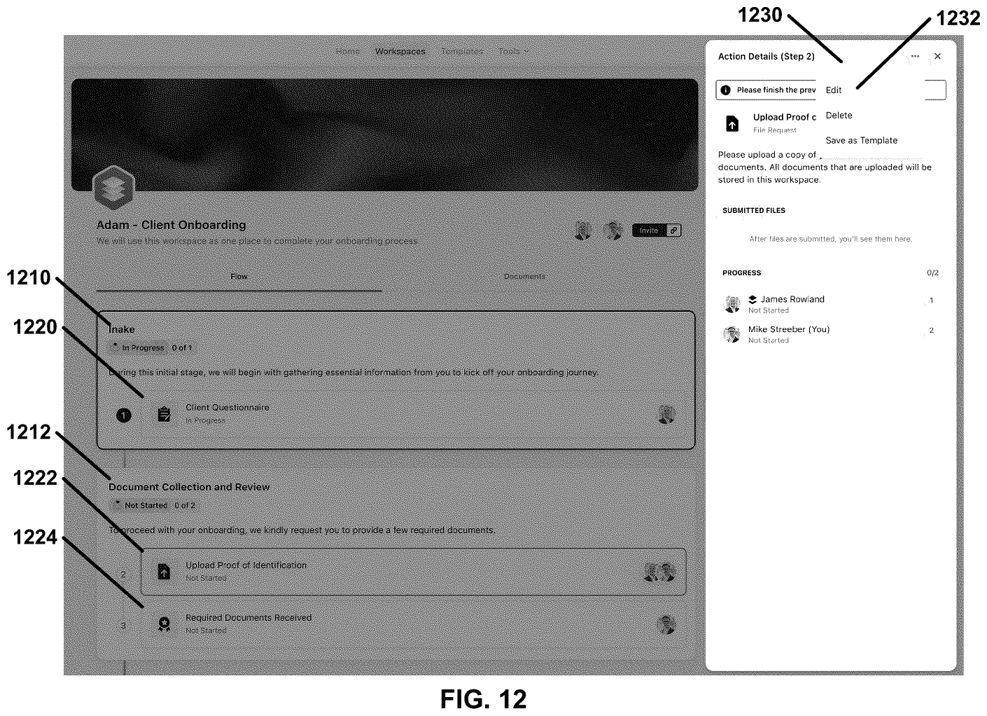

FIG. 12 illustrates an example workflow presentation with example options for modifying an example actionable item, consistent with disclosed embodiments. The workflow presentation may illustrate a workflow with a first milestone 1210. The workflow may comprise a first actionable item 1220. The first actionable item 1220 may comprise a form. In this example, the form may comprise a client questionnaire. In this example, the first actionable item 1220 is associated with the first milestone 1210. The workflow may comprise a second milestone 1212.

The workflow may comprise a second actionable item 1222. The second actionable item 1222 may comprise a file request. In this example, the file request may comprise proof of identification. The workflow may comprise a third actionable item 1224. The third actionable item 1224 may comprise an acknowledgement. In this example, the acknowledgement may comprise acknowledging that the required documents have been received. In this example, the second actionable item 1222 and the third actionable item 1224 are associated with the second milestone 1212. The workflow presentation may comprise actionable item details 1230. In this example, the actionable item details 1230 may be associated with the second actionable item 1222. The actionable item details 1230 may comprise a menu. When activated by a user, the menu may show options for modifying an actionable item 1232. In this example, the options for modifying an actionable item 1232 may comprise edit and delete.

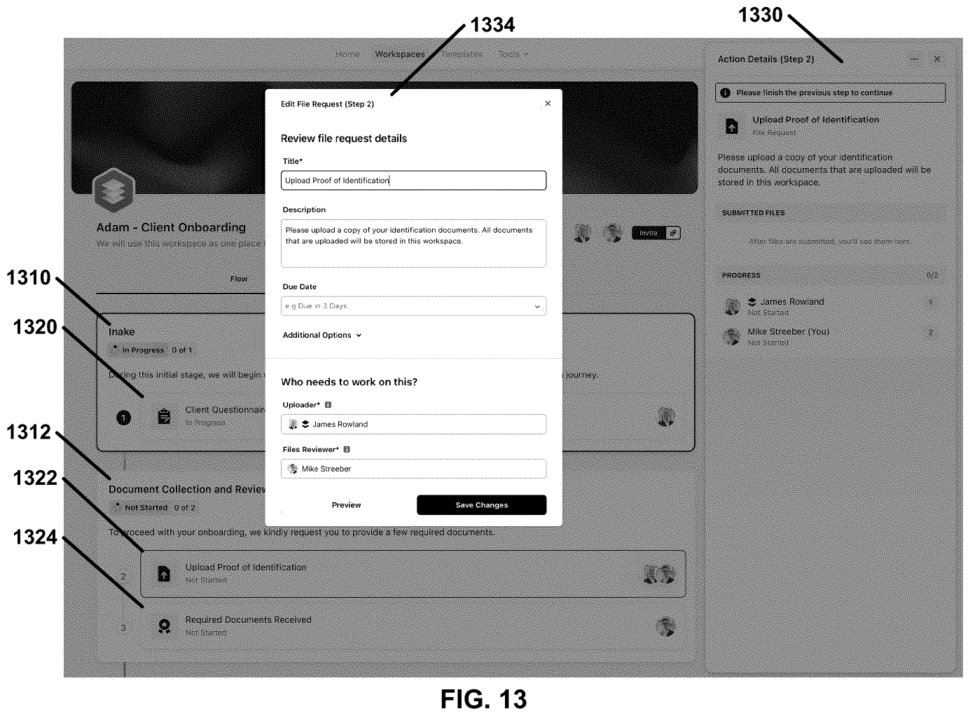

FIG. 13 illustrates an example workflow presentation with example options for editing an example actionable item, consistent with disclosed embodiments. The workflow presentation may illustrate a workflow with a first milestone 1310. The workflow may comprise a first actionable item 1320. The first actionable item 1320 may comprise a form. In this example, the form may comprise a client questionnaire. In this example, the first actionable item 1320 is associated with the first milestone 1310. The workflow may comprise a second milestone 1312. The workflow may comprise a second actionable item 1322. The second actionable item 1322 may comprise a file request. In this example, the file request may comprise proof of identification. The workflow may comprise a third actionable item 1324. The third actionable item 1324 may comprise an acknowledgement. In this example, the acknowledgement may comprise acknowledging that the required documents have been received. In this example, the second actionable item 1322 and the third actionable item 1324 are associated with the second milestone 1312. The workflow presentation may comprise actionable item details 1330. In this example, the actionable item details 1330 may be associated with the second actionable item 1322. The actionable item details 1330 may comprise a menu. When activated by a user, the menu may show options for modifying an actionable item. The options for modifying an actionable item may comprise edit. When the edit option is activated, an edit details box 1334 may be presented. In this example, the edit details box 1334 is specific to the second actionable item 1322.

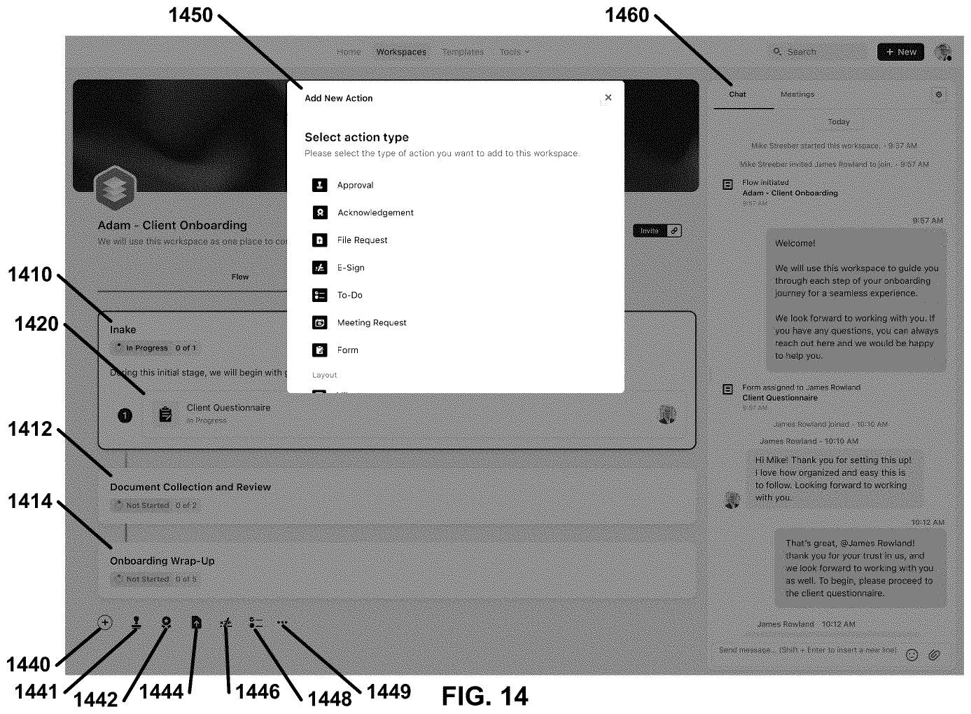

FIG. 14 illustrates an example workflow presentation after receiving an example request to modify the workflow by adding an actionable item, consistent with disclosed embodiments. The workflow presentation may illustrate a workflow with a first milestone 1410. The workflow may comprise a first actionable item 1420. The first actionable item 1420 may comprise a form. In this example, the form may comprise a client questionnaire. In this example, the first actionable item 1420 is associated with the first milestone 1410. The workflow may comprise a second milestone 1412. In this example, the second milestone is associated with two additional actionable items (not shown). The workflow may comprise a third milestone 1414. In this example, the third milestone is associated with five additional actionable items (not shown). The workflow presentation may comprise a collaboration feed 1460. The collaboration feed 1460 may be available to users associated with the workflow. A user may submit a request to modify the workflow. The request to modify the workflow may comprise adding an actionable item. As shown in this example, an actionable item type menu 1450 may be presented when a user requests to add a new actionable item. In this example, the actionable item type menu 1450 may be presented when a user selects the add actionable item button 1440. The actionable item type menu 1450 may also be presented when a user selects the add actionable item menu 1449. Alternatively, a process to add an actionable item comprising an approval may be invoked when add approval button 1441 is selected by a user. A process to add an actionable item comprising an acknowledgement may be invoked when add acknowledgement button 1442 is selected by a user. A process to add an actionable item comprising a file request may be invoked when add file request button 1444 is selected by a user. A process to add an actionable item comprising a signature may be invoked when add signature button 1446 is selected by a user. A process to add an actionable item comprising a task may be invoked when add task button 1448 is selected by a user. As shown in this example, a process to modify a workflow may be invoked while one or more actionable items (e.g., 1420) in the workflow remain actionable to one or more users viewing a presentation of the workflow.

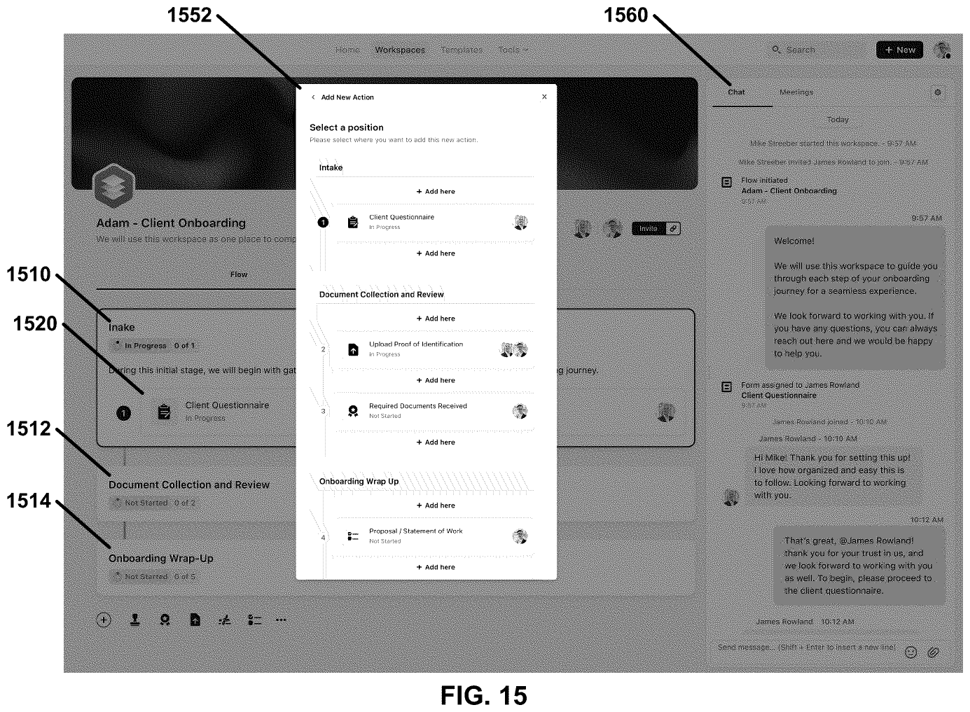

FIG. 15 illustrates an example workflow presentation with example options for adding an actionable item, consistent with disclosed embodiments. The workflow presentation may illustrate a workflow with a first milestone 1510. The workflow may comprise a first actionable item 1520. The first actionable item 1520 may comprise a form. In this example, the form may comprise a client questionnaire. In this example, the first actionable item 1520 is associated with the first milestone 1510. The workflow may comprise a second milestone 1512. The workflow may comprise a third milestone 1514. The workflow presentation may comprise a collaboration feed 1560. The collaboration feed 1560 may be available to users associated with the workflow. A user may submit a request to modify the workflow. The request to modify the workflow may comprise adding an actionable item. An actionable item type may be selected by the user. A position selector box 1552 may be presented to the user. The position selector box 1552 may comprise two or more components of the workflow (e.g., 1510, 1520, 1512, 1514). As shown in this example, a process to modify the workflow may be invoked while one or more actionable items (e.g., 1520) in the workflow remain actionable to one or more users viewing a presentation of the workflow.

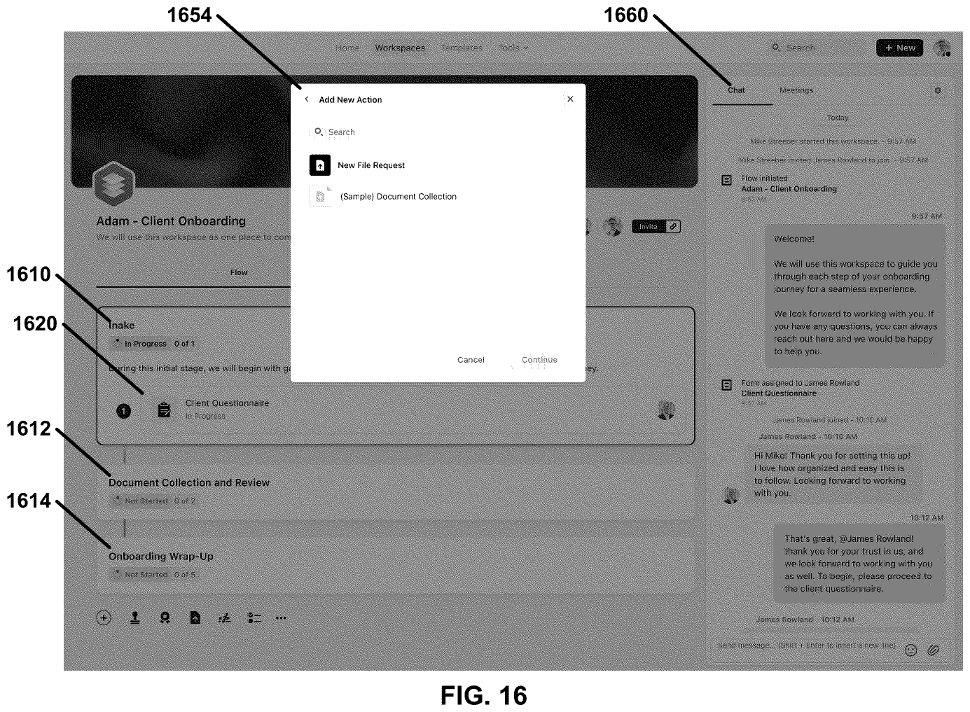

FIG. 16 illustrates an example workflow presentation after receiving an example request to modify the workflow by adding a file request, consistent with disclosed embodiments. The workflow presentation may illustrate a workflow with a first milestone 1610. The workflow may comprise a first actionable item 1620. The first actionable item 1620 may comprise a form. In this example, the form may comprise a client questionnaire. In this example, the first actionable item 1620 is associated with the first milestone 1610. The workflow may comprise a second milestone 1612. The workflow may comprise a third milestone 1614. The workflow presentation may comprise a collaboration feed 1660. The collaboration feed 1660 may be available to users associated with the workflow. A user may submit a request to modify the workflow. The request to modify the workflow may comprise adding an actionable item. An actionable item type may be selected by the user. A position for the new actionable item may be selected by the user. An add actionable item menu 1654 may be presented to the user. As shown in this example, a process to modify a workflow may be invoked while one or more actionable items (e.g., 1620) in the workflow remain actionable to one or more users viewing a presentation of the workflow.

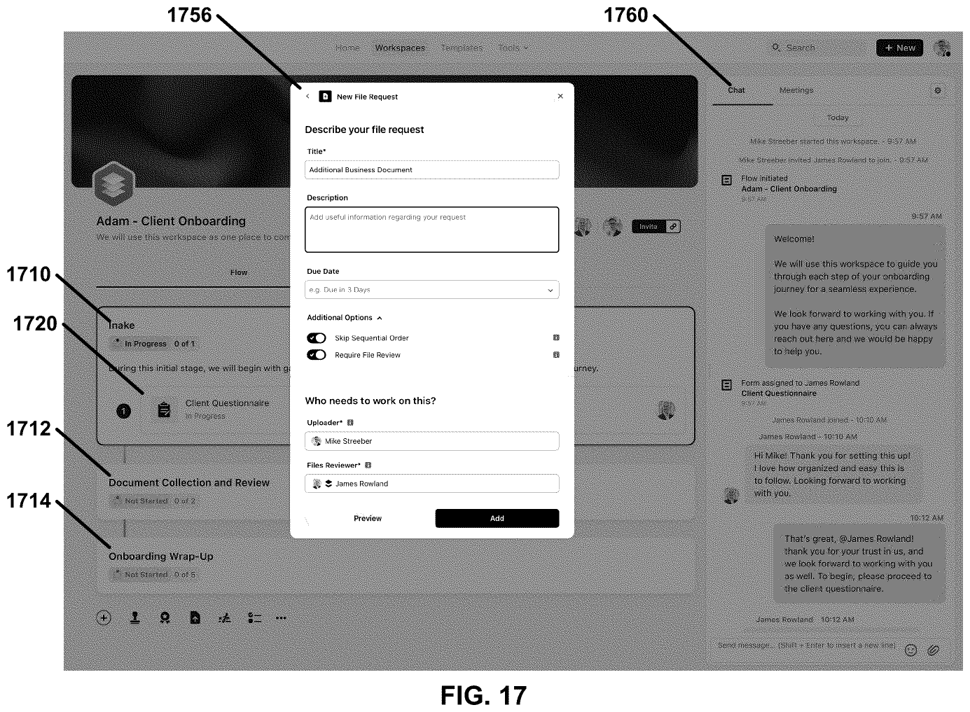

FIG. 17 illustrates an example workflow presentation with example options for adding a file request, consistent with disclosed embodiments. The workflow presentation may illustrate a workflow with a first milestone 1710. The workflow may comprise a first actionable item 1720. The first actionable item 1720 may comprise a form. In this example, the form may comprise a client questionnaire. In this example, the first actionable item 1720 is associated with the first milestone 1710. The workflow may comprise a second milestone 1712. The workflow may comprise a third milestone 1714. The workflow presentation may comprise a collaboration feed 1760. The collaboration feed 1760 may be available to users associated with the workflow. A user may submit a request to modify the workflow. The request to modify the workflow may comprise adding an actionable item. An actionable item type may be selected by the user. A position for the new actionable item may be selected by the user. A file request may be selected by the user. A file request details box 1756 may be presented to the user. As shown in this example, a process to modify a workflow may be invoked while one or more actionable items (e.g., 1720) in the workflow remain actionable to one or more users viewing a presentation of the workflow.

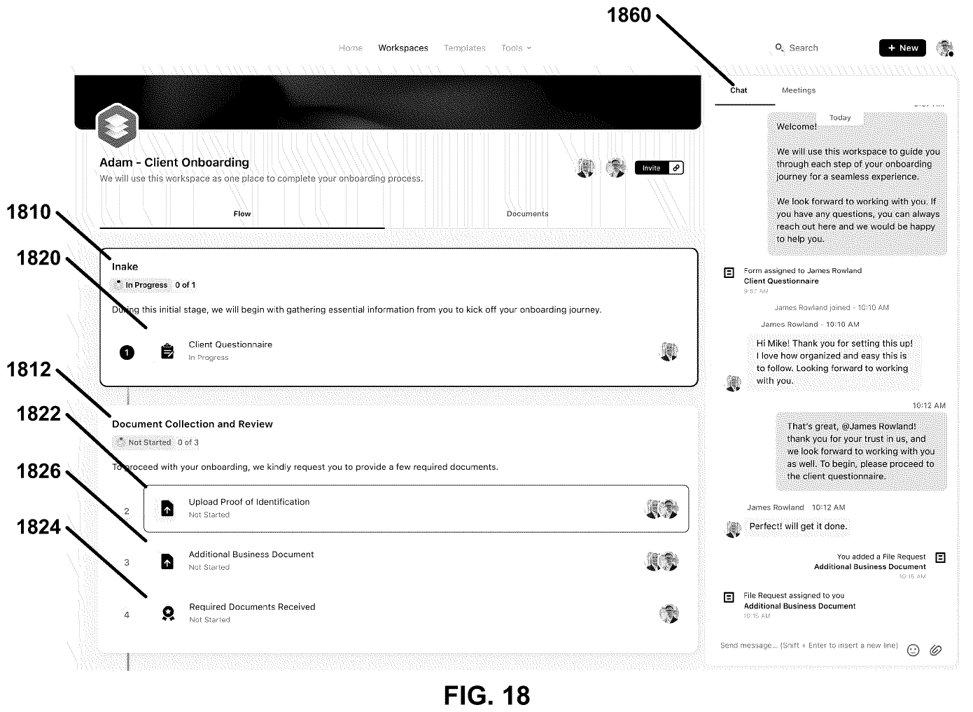

FIG. 18 illustrates an example workflow presentation after adding a file request to existing example actionable items, and a first aspect of an example collaboration feed, consistent with disclosed embodiments. The workflow presentation may illustrate a workflow with a first milestone 1810. The workflow may comprise a first actionable item 1820. The first actionable item 1820 may comprise a form. In this example, the form may comprise a client questionnaire. In this example, the first actionable item 1820 is associated with the first milestone 1810. The workflow may comprise a second milestone 1812. The workflow may comprise a second actionable item 1822. The second actionable item 1822 may comprise a file request. In this example, the file request may comprise proof of identification. The workflow may comprise a third actionable item 1824. The third actionable item 1824 may comprise an acknowledgement. In this example, the acknowledgement may comprise acknowledging that the required documents have been received. In this example, the second actionable item 1822 and the third actionable item 1824 are associated with the second milestone 1812. A user may submit a request to modify the workflow. The request to modify the workflow may comprise adding an actionable item. An actionable item type may be selected by the user. A position for the new actionable item may be selected by the user. A file request may be selected by the user. File request details may be completed by the user. The workflow may comprise the new actionable item 1826. In this example, the new actionable item 1826 may comprise the file request. The file request may be based on the actionable item type selected by the user. In this example, the new actionable item 1826 is positioned between the second actionable item 1822 and the third actionable item 1824. In this example, the new actionable item 1826 is associated with the second milestone 1812. The position of the new actionable item 1826 in the workflow may be based on the position for the new actionable item selected by the user. In this example, the file request may comprise a request for an additional business document. Details associated with the request for the additional business document may be based on the file request details completed by the user. The workflow presentation may comprise the first aspect of the collaboration feed 1860. The collaboration feed may be available to users associated with the workflow.

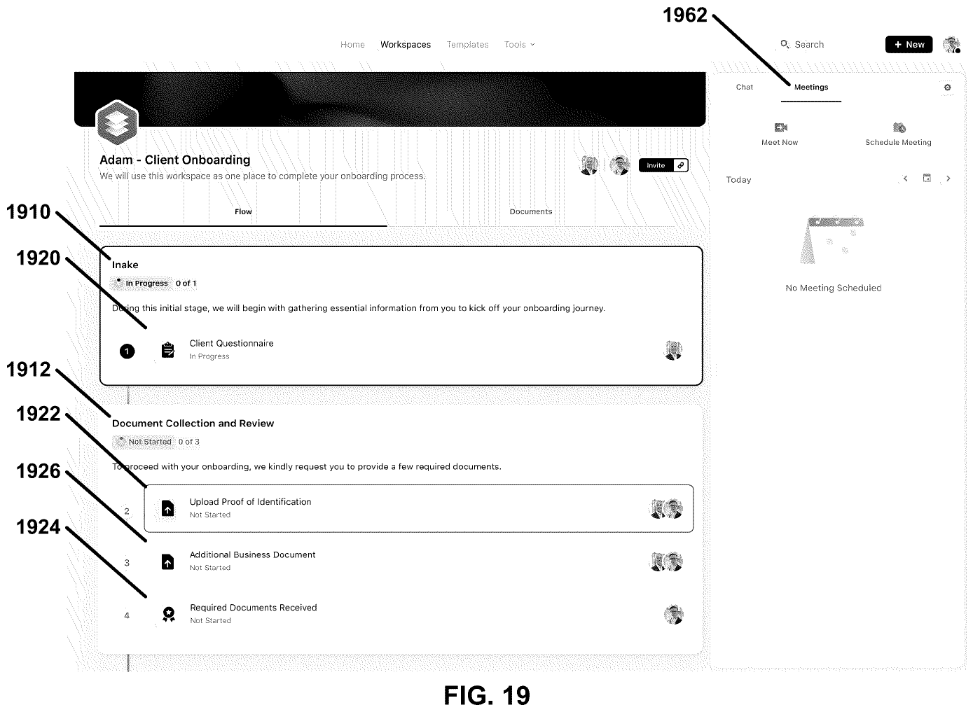

FIG. 19 illustrates an example workflow presentation and a second aspect of an example collaboration feed, consistent with disclosed embodiments. The workflow presentation may illustrate a workflow with a first milestone 1910. The workflow may comprise a first actionable item 1920. The first actionable item 1920 may comprise a form. In this example, the form may comprise a client questionnaire. In this example, the first actionable item 1920 is associated with the first milestone 1910. The workflow may comprise a second milestone 1912. The workflow may comprise a second actionable item 1922. The second actionable item 1922 may comprise a first file request. In this example, the first file request may comprise proof of identification. The workflow may comprise a third actionable item 1926. The third actionable item 1926 may comprise a second file request. In this example, the second file request may comprise an additional business document. The workflow may comprise a fourth actionable item 1924. The fourth actionable item 1924 may comprise an acknowledgement. In this example, the acknowledgement may comprise acknowledging that the required documents have been received. In this example, the second actionable item 1922, the third actionable item 1926, and the fourth actionable item 1924 are associated with the second milestone 1912. The workflow presentation may comprise the second aspect of the collaboration feed 1962. The collaboration feed may be available to users associated with the workflow. The second aspect of the collaboration feed 1962 may illustrate one or more calendar items.

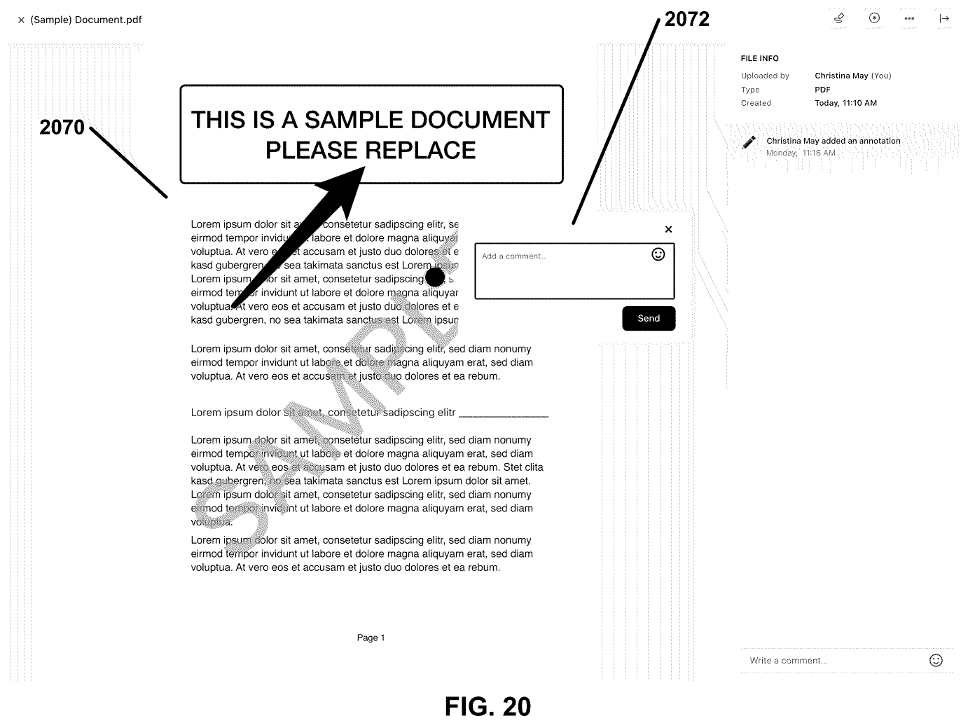

FIG. 20 illustrates an example annotation, consistent with disclosed embodiments. Users associated with a computer implemented workspace may add at least one collaboration item to a collaboration feed. The collaboration item may comprise an annotation 2072. The annotation 2072 may be associated with a document 2070.

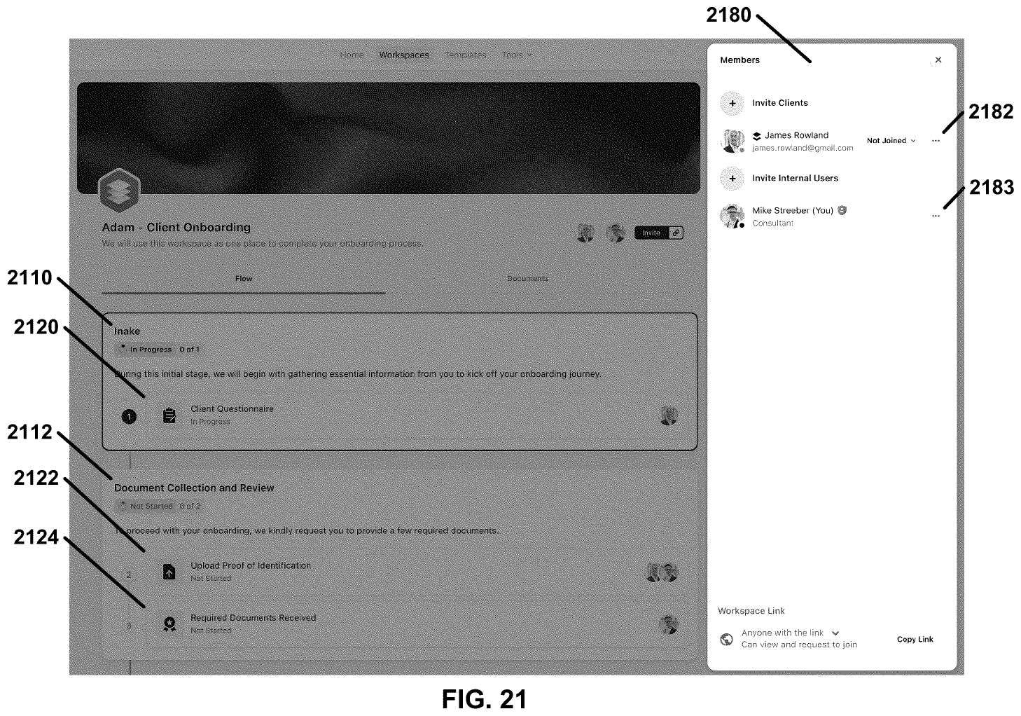

FIG. 21 illustrates an example workflow presentation with an example list of users associated with the workflow, consistent with disclosed embodiments. The workflow presentation may illustrate a workflow with a first milestone 2110. The workflow may comprise a first actionable item 2120. The first actionable item 2120 may comprise a form. In this example, the form may comprise a client questionnaire. In this example, the first actionable item 2120 is associated with the first milestone 2110. The workflow may comprise a second milestone 2112. The workflow may comprise a second actionable item 2122. The second actionable item 2122 may comprise a file request. In this example, the file request may comprise proof of identification. The workflow may comprise a third actionable item 2124. The third actionable item 2124 may comprise an acknowledgement. In this example, the acknowledgement may comprise acknowledging that the required documents have been received. In this example, the second actionable item 2122 and the third actionable item 2124 are associated with the second milestone 2112. One or more users may be associated with the workflow. A list of the users 2180 may be presented as part of the workflow presentation. A menu button (2182, 2183) may be associated with each of the users. When one of the menu buttons is selected, for example, menu button 2183, a profile menu for the associated user may be presented. The profile menu may comprise an option to reassign actionable items associated with the user to another user.

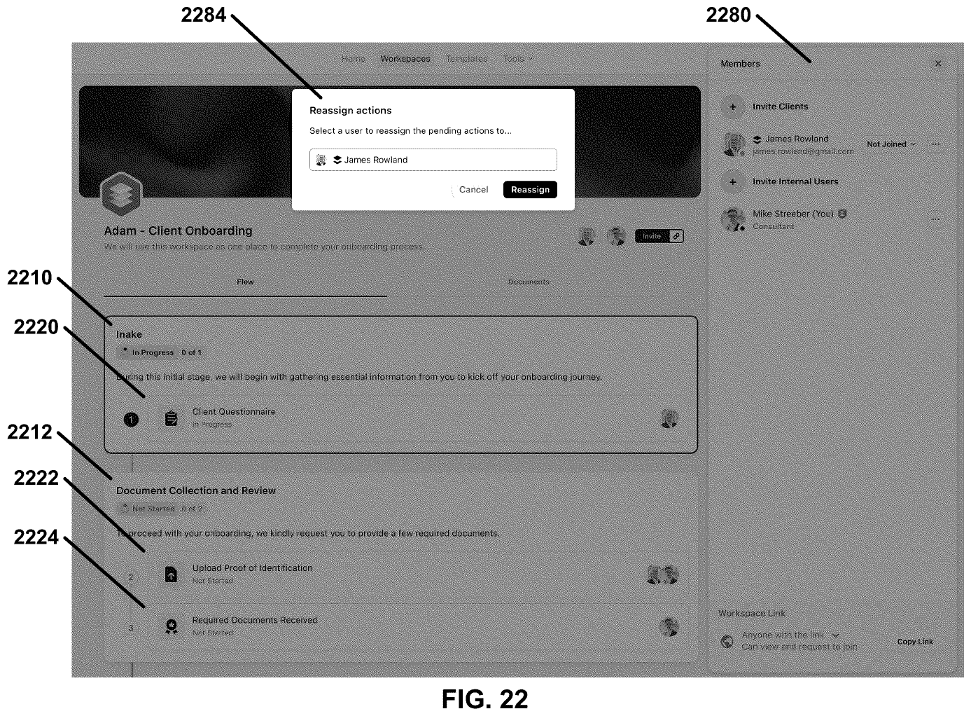

FIG. 22 illustrates an example workflow presentation with an example reassignment selection, consistent with disclosed embodiments. The workflow presentation may illustrate a workflow with a first milestone 2210. The workflow may comprise a first actionable item 2220. The first actionable item 2220 may comprise a form. In this example, the form may comprise a client questionnaire. In this example, the first actionable item 2220 is associated with the first milestone 2110. The workflow may comprise a second milestone 2112. The workflow may comprise a second actionable item 2222. The second actionable item 2222 may comprise a file request. In this example, the file request may comprise proof of identification. The workflow may comprise a third actionable item 2224. The third actionable item 2224 may comprise an acknowledgement. In this example, the acknowledgement may comprise acknowledging that the required documents have been received. In this example, the second actionable item 2222 and the third actionable item 2224 are associated with the second milestone 2212. One or more users may be associated with the workflow. A list of the users 2280 may be presented as part of the workflow presentation. One or more actionable items (e.g., 2220) may be assigned to a first user. A menu button associated with the first user may be selected. An option to reassign actionable items associated with the first user may be selected from a profile menu for the first user. A reassignment selection box 2284 may be presented. The reassignment selection box 2284 may comprise an option to select a second user to be assigned the one or more actionable items. As shown in this example, a process to reassign one or more actionable items from a first user to a second user may be invoked while a sequence of actionable items (e.g., 2220, 2222, 2224) in the workflow remain actionable to one or more users viewing a presentation of the workflow.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In this specification, “a” and “an” and similar phrases are to be interpreted as “at least one” and “one or more.” References to “a”, “an”, and “one” are not to be interpreted as “only one”. In this specification, the term “may” is to be interpreted as “may, for example.” In other words, the term “may” is indicative that the phrase following the term “may” is an example of one of a multitude of suitable possibilities that may, or may not, be employed to one or more of the various embodiments. In this specification, the phrase “based on” is indicative that the phrase following the term “based on” is an example of one of a multitude of suitable possibilities that may, or may not, be employed to one or more of the various embodiments. References to “an” embodiment in this disclosure are not necessarily to the same embodiment.

Many of the elements described in the disclosed embodiments maybe implemented as operations. An operation is defined herein as an isolatable element that performs a defined function and has a defined interface to other elements. The operations described in this disclosure may be implemented in hardware, software, a combination of hardware and software, firmware, wetware (in other words, hardware with a biological element), or a combination thereof, all of which are behaviorally equivalent. For example, operations may be implemented using computer hardware in combination with software routine(s) written in a computer language (for example, Java, HTML, XML, PHP, Python, ActionScript, JavaScript, Ruby, Prolog, SQL, VBScript, Visual Basic, Perl, C, C++, Objective-C, Rust, and/or any other computer language). Additionally, it may be possible to implement operations using physical hardware that incorporates discrete or programmable analog, digital, and/or quantum hardware. Examples of programmable hardware include: computers, microcontrollers, microprocessors, application-specific integrated circuits (ASICs), field programmable gate arrays (FPGAs), and complex programmable logic devices (CPLDs). Computers, microcontrollers, and microprocessors may be programmed using languages such as assembly, C, C++, and/or any other computer language. FPGAs, ASICs, and CPLDs are often programmed using hardware description languages (HDL) such as VHSIC hardware description language (VHDL) or Verilog that configure connections between internal hardware operations with lesser functionality on a programmable device. Finally, it needs to be emphasized that the above-mentioned technologies may be used in combination to achieve the result of a functional operation. Automatic operations are performed automatically and do not require human intervention to complete once executed. Automatic as defined herein does not include any time limitations unless otherwise noted.

Some embodiments may employ processing hardware. Processing hardware may comprise one or more processors, microprocessors, computer equipment, embedded systems, machines, and/or the like. Processing hardware may comprise one or more single core or multiple core processors that executes parallel processes simultaneously. For example, a processor may be a single core processor configured with virtual processing technologies. In some embodiments, a processor may use logical processors to simultaneously execute and control multiple processes. Processing hardware may implement virtual machine technologies, or other known technologies to provide the ability to execute, control, run, manipulate, and/or store multiple software processes, applications, programs, and/or the like. In another example, a processor may include a multiple core processor arrangement (e.g., dual core, quad core, etc.) configured to provide parallel processing functionalities to allow execution of multiple processes simultaneously. One of ordinary skill in the art would understand that other types of processor arrangements could be implemented that provide for the capabilities disclosed herein. The disclosed embodiments are not limited to any type of processor.

Some embodiments may employ programs. Programs may comprise instructions configured to cause processing hardware to perform operations. Programs may include one or more programs (e.g., modules, code, scripts, or functions) used to perform methods consistent with disclosed embodiments. Programs may include operating systems that perform known operating system functions when executed by one or more processors. Disclosed embodiments may operate and function with computer systems running any type of operating system. Programs may be written in one or more programming or scripting languages. In some embodiments, programs may be implemented or replicated as firmware or circuit logic. The programs and/or instructions may be stored on a machine-readable medium or memory. A memory (e.g. automated data medium) may be a medium configured to store data in a machine-readable format that may be accessed by an automated sensing device. According to some embodiments, a memory may include a volatile or nonvolatile, magnetic, semiconductor, optical, removable, non-removable, or other type of storage device or tangible (i.e., non-transitory) computer readable medium, consistent with disclosed embodiments. A memory may comprise data, instructions, programs, and/or other components.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described example embodiments. In particular, it should be noted that, for example purposes, various embodiments include an automated workflow system and a user device. However, one skilled in the art will recognize that the system and user device may vary from a traditional server/device relationship over a network such as the internet. For example, a system may be collective based: portable equipment, broadcast equipment, virtual, application(s) distributed over a broad combination of computing sources, part of a cloud, and/or the like. Similarly, for example, a user device may be a user based client, portable equipment, broadcast equipment, virtual, application(s) distributed over a broad combination of computing sources, part of a cloud, and/or the like. Additionally, it should be noted that, for example purposes, several of the various embodiments include instructions. However, one skilled in the art will recognize that many various languages and frameworks may be employed to build and use embodiments of the present invention.

In this specification, various embodiments are disclosed. Limitations, features, and/or elements from the disclosed example embodiments may be combined to create further embodiments within the scope of the disclosure. Moreover, the scope includes any and all embodiments having equivalent elements, modifications, omissions, adaptations, or alterations based on the present disclosure. Further, aspects of the disclosed methods can be modified in any manner, including by reordering aspects, or inserting or deleting aspects.

In addition, it should be understood that any figures that highlight any functionality and/or advantages, are presented for example purposes only. The disclosed architecture is sufficiently flexible and configurable, such that it may be utilized in ways other than that shown. For example, the blocks presented in any flowchart may be re-ordered or only optionally used in some embodiments.

Furthermore, many features presented above are described as being optional through the use of “may” or the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features, or with all three of the three possible features.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. An automated workflow system coupled to a computer network, the system comprising:
a) a workflow template database configured to store a plurality of workflow templates, each of the workflow templates comprising a workflow having a sequence of actionable items;
b) at least one memory storing instructions; and
c) at least one processor configured to execute the instructions to perform operations, the operations comprising:
i) electronically communicating first workflow presentation instructions to a user device, the first workflow presentation instructions configured to present the workflow to a user of the user device;
ii) electronically receiving workflow modification instructions from the user device, the workflow modification instructions comprising a request to modify the workflow;
iii) automatically generating a modified workflow based on the workflow modification instructions; and
iv) electronically communicating second workflow presentation instructions to the user device, the second workflow presentation instructions configured to present the modified workflow to the user.

2. The system according to claim 1, wherein the workflow modification instructions are received from the user device while the sequence of actionable items remain actionable to the user.

3. The system according to claim 1, wherein the actionable items comprise one or more of the following:
a) a form;
b) a file request;
c) an approval;
d) an acknowledgement;
e) a signature;
f) a calendar item;
g) a task; or
h) an integration.

4. The system according to claim 1, wherein the request to modify the workflow comprises adding an actionable item.

5. The system according to claim 1, wherein the request to modify the workflow comprises removing an actionable item.

6. The system according to claim 1, wherein the request to modify the workflow comprises marking an actionable item as complete.

7. The system according to claim 1, wherein one or more of the actionable items includes access to an API associated with a third party service.

8. The system according to claim 1, further coupled to an audit database, and the operations further comprising storing the workflow modification instructions in the audit database.

9. The system according to claim 1, wherein one or more of the actionable items is assignable to one or more users.

10. The system according to claim 9, wherein each of the users is associated with the workflow.

11. The system according to claim 10, the operations further comprising:
a) electronically receiving reassignment instructions, the reassignment instructions comprising a request to reassign one or more of the actionable items from a first user to a second user;
b) automatically generating an updated workflow based on the reassignment instructions; and
c) electronically communicating updated workflow presentation instructions to the user device, the updated workflow presentation instructions configured to present the updated workflow.

12. The system according to claim 11, further coupled to an audit database, and the operations further comprising storing the reassignment instructions in the audit database.

13. The system according to claim 1, the operations further comprising:
a) electronically communicating first feed instructions to the user device, the first feed instructions configured to present a collaboration feed to the user;
b) electronically receiving collaboration instructions from the user device, the collaboration instructions comprising a request to add a collaboration item to the collaboration feed;
c) automatically generating a modified collaboration feed based on the collaboration instructions; and
d) electronically communicating second feed instructions to the user device, the second feed instructions configured to present the modified collaboration feed to the user.

14. The system according to claim 13, wherein the collaboration instructions are received from the user device while the sequence of actionable items remain actionable.

15. The system according to claim 13, wherein the collaboration item comprises one or more of the following:
a) a message comprising text;
b) a message comprising a video;
c) a request for a video meeting;
d) a file;
e) a link to a file;
f) a link to a data repository; or
g) an annotation.

16. The system according to claim 13, wherein the collaboration feed and the modified collaboration feed are associated with a specific actionable item.

17. The system according to claim 13, wherein the collaboration feed and the modified collaboration feed are associated with all of the actionable items.

18. The system according to claim 13, further coupled to an audit database, and the operations further comprising storing the collaboration instructions in the audit database.

19. A method for automating workflow, the method comprising:
a) accessing a workflow template database configured to store a plurality of workflow templates, each of the workflow templates comprising a workflow having a sequence of actionable items;
b) electronically communicating first workflow presentation instructions to a user device, the first workflow presentation instructions configured to present the workflow to a user of the user device;
c) electronically receiving workflow modification instructions from the user device, the workflow modification instructions comprising a request to modify the workflow;
d) automatically generating a modified workflow based on the workflow modification instructions; and
e) electronically communicating second workflow presentation instructions to the user device, the second workflow presentation instructions configured to present the modified workflow to the user.

20. The method according to claim 19, wherein the workflow modification instructions are received from the user device while the sequence of actionable items remain actionable to the user.
